(19) United States
(12) Patent Application Publication
(10) Pub. No.: US 2003/0055128 A1
(43) Pub. Date: Mar. 20, 2003

(54) Aqueous fluorescent inks for free ink writing instruments

(76) Inventor: Derrick J. Jakubchak, Simpsonville, SC (US)

Correspondence Address: PENNIE AND EDMONDS, 1155 AVENUE OF THE AMERICAS, NEW YORK, NY, 100362711

(21) Appl. No.: 09/900,914

(22) Filed: Jul. 9, 2001

(51) Int. Cl. C03C 17/00; C09D 5/00

(52) U.S. Cl. 523/160; 523/161

(57) ABSTRACT

A fluorescent ink composition suitable for use in free ink writing instruments is described comprising a fluorescent pigment dispersion, a water miscible organic solvent, a defoaming agent, and water. The ink composition may also include additives such as an additive to increase cap-off stability. The ink composition flows smoothly and continuously from a free ink writing instrument.

### FIELD OF INVENTION

The present invention relates to a fluorescent ink composition for free ink writing instruments and free ink writing instruments making use of the ink composition. The ink composition comprises a fluorescent pigment dispersion, a water-miscible organic solvent, a defoaming agent, and water.

### BACKGROUND OF INVENTION

Current bright ink pens are generally gel ink pens requiring a grease follower and point seal feature or “free ink” pens requiring a flow control mechanism such as a baffle and/or capillary connectors. Disadvantages to gel ink pens include additional production steps, additional cost to their production, poor writing quality (such as scratchiness, dual tracking, and uneven ink laydown) and short shelf life. Free ink pens are more desirable than gel ink pens because free ink pens deliver a smooth, consistent ink line. A major disadvantage to using free ink pens is the need for excellent ink-to-pen interior wetting. If ink in free ink pens does not wet the pen interior well or if it foams excessively during use, then the pen will not deliver a smooth continuous ink line to paper.

European Patent EP 0 344 379 to Nippon Keiko Kaguki Co., Ltd. discloses a water-colour fluorescent ink for writing instruments comprising 30 to 70% by weight of a dyed material; and 5 to 35% by weight of a hydrophilic organic solvent such as glycerol and/or propylene glycol. The dyed material is obtained by providing a monomeric mixture consisting of 10% to 80% by weight of acrylonitrile, 0.5 to 20% by weight of (metha)acrylic acid, and the balance of styrene; emulsifying and polymerizing the monomeric mixture; and dyeing the emulsified polymers with a fluorescent dye. The ink may also contain a defoaming agent. EP 0 344 379 does not disclose a writing instrument which allows the ink to flow freely within the pen barrel as in the present invention because the ink in EP 0 344 379 is constrained within a polyester fiber pad.

U.S. Pat. No. 5,913,972 to Kanou et al. discloses an aqueous pigment dispersion formed of a pigment, an aqueous medium, and a dispersant resin. The resin contains sulfonic groups or their salts. U.S. Pat. No. 5,913,972 does not disclose the fluorescent pigment dispersion of the present invention which does not use a sulfonic acid containing dispersing resin.

U.S. Pat. No. 4,460,727 to Shoji discloses a water based pigment ink composition for writing. This ink composition comprises a pigment, a dispersing agent, an anti-drying agent, and an aqueous medium. Any pigment may be used. The dispersing agent is a water soluble amine salt or ammonium salt of a copolymer comprising at least 50 molar % of a hydrophobic addition-polymerizable monomer and less than 50 molar % of acrylic acid or methacrylic acid. The aqueous medium includes a water-soluble organic solvent. A surfactant may also be added to the ink composition. U.S. Pat. No. 4,460,727 does not disclose the use of the ink composition in a free ink writing instrument.

Japanese Patent JP 6,346,013 to Hattori Testsuya et al. discloses a water-based fluorescent pigment ink for a marking pen comprising water, lactitol, and a fluorescent pigment dispersed therein. The ink may also include a defoaming agent and a humectant such as glycerine. JP 6,346,013 does not disclose the use of the ink in a free ink writing instrument.

U.S. Pat. No. 5,719,204 to Beach et al. discloses aqueous ink compositions for use in ink jet printers comprising from about 0.5% to about 10% of an insoluble pigment, from about 0.25% to about 10% of a polymeric dispersant, and an aqueous carrier. The aqueous carrier medium comprises water and at least one water soluble organic solvent. A surfactant may also be added to the ink. U.S. Pat. No. 5,719,204 does not disclose the use of the ink in a free ink writing instrument nor does U.S. Pat. No. 5,719,204 disclose the use of a defoaming agent to increase the writing efficiency of the ink in a free ink pen as does the present invention.

U.S. Pat. No. 5,580,374 to Okumura et al. discloses an aqueous ink composition for ballpoint pens. This composition comprises 2,5-dimercapto-1,3,4-thiadiazole or its salt, a pigment such as an organic fluorescent pigment, a dispersant, water, and a water-soluble organic solvent. Surface active agents can be used as the dispersant. U.S. Pat. No. 5,580,374 does not disclose an ink composition that includes a fluorescent pigment dispersion and a defoaming agent.

Japanese Patent JP 2000104001 to Uchida Tatsumi discloses a phosphorescent pigment ink composition for a writing utensil. The phosphorescent pigment ink composition comprises a phosphorescent pigment, a resin, and an organic solvent. JP 2000104001 does not disclose a fluorescent ink for use in a free ink pen.

U.S. Pat. No. 6,176,910 B1 to Miyazaki et al. discloses a pseudoplastic water based ink for a gel ink pen. The ink comprises a colorant, a dispersant, water, and a polar solvent, and a viscosity-controlling agent. When the colorant is a pigment, a water-soluble polymer dispersant and a surfactant must be used. The polar solvent is any water miscible solvent such as propylene glycol and glycerin. The viscosity-controlling agent provides the ink with pseudoplasticity. Lubricants such as nonionic surfactants may be also added to the ink. U.S. Pat. No. 6,176,910 B1 does not disclose the use of the ink in a free ink writing instrument whose viscosity is Newtonian not pseudoplastic.

U.S. Pat. No. 6,099,629 to Morita et al. discloses a water based ink having a metallic lustrous color for a ballpoint pen. The ink contains an aluminum powder, a water-soluble organic solvent, a pigment, a thickener, and a resin. Dispersion aids and defoaming agents may also be added to the ink. The pigments are dispersed and have an average particle diameter in the range of 0.03 to 0.3 μm. U.S. Pat. No. 6,099,629 does not disclose a fluorescent pigment dispersion nor does it disclose a fluorescent ink for use in a free ink pen which uses a defoaming agent to increase the writing efficiency of the pen as does the present invention.

U.S. Pat. No. 6,037,391 to Iida discloses a water based dye ink composition for a free ink rollerball pen. The ink composition comprises a water-soluble dye, an aqueous medium, and white resin particles which are insoluble in an aqueous medium. A water-soluble organic solvent and a surfactant may also be added. U.S. Pat. No. 6,037,391 does not disclose a fluorescent pigment dispersion nor does it disclose a fluorescent ink for use in a free ink pen which uses a defoaming agent to increase the writing efficiency of the pen as does the present invention.

U.S. Pat. No. 5,837,045 to Johnson et al. discloses an aqueous composition such as a liquid ink comprising a water-based liquid vehicle and a surface-modified colored pigment. The surface-modified colored pigment is as small as possible to enable a stable colloidal suspension of the pigment in the liquid vehicle. The composition may further comprise at least one additive such as a defoaming agent and a humectant such as proplyene glycol or glycerine. U.S. Pat. No. 5,837,045 does not disclose the use of the composition in a free ink pen nor does it disclose a fluorescent ink for use in a free ink pen which uses a defoaming agent to increase the writing efficiency of the pen as does the present invention.

There is a need for a free ink writing instrument that uses aqueous fluorescent ink compositions wherein the ink composition includes a fluorescent pigment dispersion, a water-miscible organic solvent, a defoaming agent, and water that is formulated for use in a free ink writing instrument, wherein the defoaming agent eliminates foam formation in the ink within the pen and allows the ink to intimately wet the interior of the free ink pen and permits the free ink pen to deliver a smooth continuous ink line to the paper. This invention satisfies this need.

### SUMMARY OF INVENTION

The ink of the present invention discloses a bright fluorescent ink composition that can be delivered smoothly and continuously from a free ink writing instrument.

In one embodiment of the invention, a fluorescent ink composition for a free ink writing instrument comprises a fluorescent pigment dispersion, a water miscible organic solvent, a defoaming agent, and water, wherein the fluorescent pigment dispersion is a fluorescent colorant dispersed in a non-sulfonic acid-group containing resin. The defoaming agent reduces foam and provides wetting properties in an interior delivery system of the free ink writing instrument to provide continuous writing.

The defoaming agent of the present invention is a non-ionic, non-silicone additive. Preferably, the defoaming agent is a hydrocarbon based defoaming agent. Most preferably, the defoaming agent is a mineral oil defoaming agent.

Preferably, the defoaming agent is present in the ink composition in an amount of about 1.0 weight percent or less of the ink composition, and more preferably about 0.01 weight percent to about 0.04 weight percent of the ink composition.

Preferably the viscosity of the ink composition of the present invention is about 100 cPs or less at 20° C.

Preferably, the surface tension of the ink composition is about 37 dyne-cm or less.

Preferably, the fluorescent pigment dispersion is present in the ink composition in an amount from about 0.1 to about 60 weight percent of the ink composition. Also, the fluorescent pigment dispersion comprises an organic fluorescent pigment. The pigment preferably has a particle diameter of about 1.0 micron or less, and more preferably about 0.5 micron or less.

The organic solvent is preferably from about 5 to about 90 weight percent of the ink composition, and more preferably from about 20 to about 65 weight percent of the ink composition. The organic solvent is selected from the group consisting of hydrocarbons, alcohols, esters, polyols, polyol ethers, ketones, pyrrolidones, lactones and mixtures thereof. The polyol solvent is selected from the group consisting of ethylene glycol, diethylene glycol, triethylene glycol, polyethlene glycol, propylene glycol, 1,3propane diol, 1,5-pentane diol, 1,2,6-hexane triol, glycerol and mixtures thereof.

The ink composition may include an additive to increase cap-off stability. A preferred additive to increase cap-off stability is urea.

In another embodiment of the present invention, a writing instrument comprises an ink storage member or tube containing inks of the present invention. An ink storage member or tube may be made from any of the following polymer materials: polyesters, polystyrene, high impact polystyrene, styrene-butadiene copolymers, impact modified styrene-butadiene copolymer, styrene acrylonitrile copolymers, acrylonitrile butadiene copolymers, polyisobutylene, vinyl, polyvinyl chloride, polyvinylidene chloride, polyvinyl acetals, polyacrylonitrile, polyacrylates, polymethacrylates, polymethylmethacrylates, polybutadiene, ethylene vinyl acetate, polyamides, such as nylon, polyimides, polyoxymethylene, polysulfones, polyphenylene sulfide, polyvinyl esters, melamines, vinyl esters, epoxies, polycarbonates, polyurethanes, polyether sulfones, polyacetals, phenolics, polyester carbonate, polyethers, polyethylene terephthalate, polytrimethylene terephthalate, polybutylene terephthalate, polyarylates, polyarylene sulfides, polyketones, polyethylene, high density polyethylene, polypropylene, fluoropolymers, copolymers, grafts, blends, or mixtures thereof. Also, any ink member or tube made from the polymers listed above may also be modified by a surface treatment such as fluorination, corona oxidation and the like to improve performance of the ink delivery. Preferably, the ink storage member is made of a polymer material such as fluoropolymer, vinyl, nylon and fluorinated polypropylene.

Many colors and blends are envisioned in the present invention. Further, the inks of the present invention exhibit a smooth writing performance.

### DESCRIPTION OF PREFERRED EMBODIMENTS

The present invention comprises a fluorescent pigment dispersion, a water miscible organic solvent, a defoaming agent, and water.

As used herein, the term “fluorescence” refers to the emission of visible light after absorbing daylight radiation.

As used herein, the term “pigment” refers to an insoluble solid which remains insoluble throughout the coloration process. The amount of pigment depends upon the desired color.

As used herein, the term “fluorescent pigment dispersion” is an insoluble fluorescent colorant dispersed in a non-sulfonic acid-group containing resin. The fluorescent colorant exhibits the phenomenon of fluorescence in the visible region of the spectrum. The fluorescent pigment dispersion is a heterogeneous ink composition, as opposed to a homogeneous ink composition.

As used herein, the term “free ink” writing instrument is a writing instrument which uses a free-flowing ink (viscosity less than 100 cps at 25° C.) wherein said free-flowing ink is controlled within the pen by the use of components inside the pen (such as plate-like baffles) which make use of capillary forces. Thus, the ink is held in an ink reservoir in the barrel of the writing instrument in a “free state” rather than in a restricted state (such as in a fiber reservoir). The ink composition of the present invention is formulated for use in the free ink writing instrument. The viscosity of the ink compositions of the present invention is that usable for a free ink writing instrument. Preferably the viscosity of the ink composition of the present invention is about 100 cPs or less at 20° C.

The term “about,” as used herein in connection with one or more numbers or numerical ranges, should be understood to refer to all such numbers, including all numbers in a range.

As used herein, the term “writing efficiency” or “writing performance” is known by one skilled in the art to mean, for example, a reduction in the amount of skipping, gooping, blobbing, blotting, bleeding, and globbing as the ink is dispensed from the writing instrument and on to paper. Pens exhibiting improved writing efficiency deliver a uniform layer of ink at usual writing speeds and produce a uniform script. Measurements of writing efficiency have been described, for example, in Example 3 in the Example Section and U.S. Pat. Nos. 6,099,629; 6,142,452; and 6,048,914.

As used herein, the term “defoaming agent” is a substance used to reduce foaming that may interfere with continuous and smooth flow of the ink from the writing instrument. The defoaming agent of the present invention is a nonionic, non-silicone additive used to reduce foaming in the ink composition. Preferably, the defoaming agent also increases the writing efficiency of the ink in the writing instrument.

Preferably, the defoaming agent is used in an amount of about 1.0 weight percent or less of the ink composition, and more preferably, about 0.01 weight percent to about 0.04 weight percent of the ink composition. The defoaming agent controls excessive ink foaming commonly found in free ink pens. The use of a defoaming agent results in continuous, smooth, and controlled delivery of the ink to the point of the writing instrument and, thus, to the paper without breaking or skipping. Preferably, the use of a defoaming agent produces an ink composition with a surface tension of about 37 dyne-cm or less. Most preferably, the use of a defoaming agent produces an ink composition with a surface tension of about 33 dyne-cm or less.

The defoaming agent of the present invention may be used alone or in the form of a mixture of two or more defoaming agents. Examples of suitable defoaming agents include hydrocarbon based defoaming agents. A preferred hydrocarbon based defoaming agent is a mineral oil based defoaming agent. (e.g. Foammaster® S made by Cognis in Kankakee, Ill., Patcote® 804, Patcote® 841, Patcote® 883, and Patcote® 8060 made by Patco Additives in Kansas City, Mo.). Preferably, the defoaming agent is a nonionic, non-silicone defoaming agent. A preferred defoaming agent is mineral oil with silica particles dispersed within it. A defoaming agent containing a sub-micron silica in mineral oil functions by mechanically breaking the foam cell structure formed in the ink inside the writing instrument.

Example 3 in the Example Section provides a test for determining ink mileage, or the total length of an ink line before the writing instrument stops writing. Preferably, the ink mileage is about 90% or more. The defoaming agent reduces foam and wets the interior delivery system of the writing instrument for continuous writing. This defoaming agent imparts long, uninterrupted flow of the ink composition from the free ink writing instrument.

The fluorescent pigment dispersion is an insoluble fluorescent colorant dispersed in a liquid medium. The preparation of a fluorescent pigment dispersion is known to one skilled in the art. Examples of making a fluorescent pigment dispersion are disclosed in U.S. Pat. No. 5,439,971 to Hyche and U.S. Pat. No. 3,455,856 to Voedisch. Fluorescent pigment dispersions are also commercially available.

Any daylight fluorescent colorant can be used in the present invention. Examples of daylight fluorescent compounds are the rhodamine, fluorescein, coumarin, naphthalimide, benzoanthene and acridine families. Suppliers of fluorescent colorants are Radiant Color Company (San Francisco, Calif.), Day-Glo Color Corp. (Cleveland, Ohio), Sun Chemical Co. (Cincinnati, Ohio), Sinloihi Co. Ltd. (Tokyo, Japan), Swada (London, England), Mikuni Color Works Ltd. (Himaji, Japan), Matsui International Co, Inc. (Japan), Tayca Corporation (Japan), and Nippon Keiko Color Company (Japan). Examples of suitable fluorescent pigments dispersed in a resin available commercially are “Lumikol” (Nippon Keiko Kagaku Ltd.), Radiant Color (San Francisco, Calif.), and Sun Chemical (Cincinnati, Ohio).

The pigment preferably has a particle diameter of about 1.0 micron or less, and more preferably about 0.5 micron or less.

The fluorescent pigment of the present invention may be used alone or in the form of a mixture of two or more fluorescent pigments. Preferably, the fluorescent pigment dispersion is present in the ink composition in amount from about 0.1 to about 60 weight percent of the ink composition.

The organic solvent of the present invention may be used alone or in the form of a mixture of two or more organic solvent. Examples of the water-miscible organic solvent include polyhydric alcohols such as ethylene glycol, diethylene glycol, triethylene glycol, polyethlene glycol, propylene glycol, 1,3-propane diol, 1,5-pentane diol, 1,2,6-hexane triol and glycerol; ethers of polyhydric alcohols such as ethylene glycol monomethyl ether, diethylene glycol monobutyl ether, triethylene glycol monobutyl ether and dipropylene glycol monomethyl ether; and nitrogen-containing solvents such as formamides, dimethylformamide, diethanolamine, triethanolamine, 1,3-dimethyl-2-imidazolidinone, 2-pyrrolidone and N-methyl-2-pyrrolidone.

An additive to increase cap-off stability and provide long term storage stability may also be added to the ink composition of the present invention. A preferred additive to increase cap-off stability is urea or an alkyl-substituted urea. The additive to increase cap-off stability of the present invention may be used alone or in the form of a mixture of two or more additives.

Additional components may be added to the ink compositions of the present invention. Preferred components include an anti-microbial additive and an anti-corrosive additive. The total amount of such additional components is preferably from about 0.1 weight percent to about 30 weight percent and most preferably, from about 1 weight percent to about 15 weight percent. The additional components of the present invention may be used alone or in the form of a mixture of two or more additional components.

The ink composition of the present invention provides permanence on paper. A test for permanence is described in Example 2 in the Example Section.

In another embodiment of the present invention, a writing instrument comprises an ink storage member or tube containing inks of the present invention. An ink storage member or tube may be made from any of the following polymer materials: polyesters, polystyrene, high impact polystyrene, styrene copolymers, acrylonitrile butadiene copolymers, polyisobutylene, vinyl, polyvinyl chloride, polyvinylidene chloride, polyvinyl acetals, polyacrylonitrile, polyacrylates, polymethacrylates, polymethylmethacrylates, polybutadiene, ethylene vinyl acetate, polyamides, such as nylon, polyimides, polyoxymethylene, polysulfones, polyphenylene sulfide, polyvinyl esters, melamines, vinyl esters, epoxies, polycarbonates, polyurethanes, polyether sulfones, polyacetals, phenolics, polyester carbonate, polyethers, polyethylene terephthalate, polytrimethylene terephthalate, polybutylene terephthalate, polyarylates, polyarylene sulfides, polyketones, polyethylene, high density polyethylene, polypropylene, fluoropolymers, copolymers, grafts, blends or mixtures thereof. Also, any ink member or tube made from the polymers listed above may also be modified with surface treatments such as fluorination, corona oxidation and the like to improve performance of the ink delivery. Preferably, the ink storage member is made of a polymer material such as fluoropolymer, vinyl, nylon and fluorinated polypropylene. Most preferably, the polymer material is a polypropylene made by Solvay located in Houston, Tex.

The ink storage member may be clear such that the fluorescent color of the ink can be seen through the barrel of the writing instrument.

### EXAMPLES

The ink compositions of the present invention are best described by using the following examples; however, the invention is not limited thereto. All components are listed as parts by weight (pbw) unless otherwise noted.

### Example 1

This Example shows the composition of seven “free ink” aqueous ink formulations.

| Components | A | B | C | D | E | F | G |
|---|---|---|---|---|---|---|---|
| Water | 23.75 | 23.76 | 23.76 | 23.76 | 23.76 | 23.76 | 23.76 |
| Nipagin A¹ | 0.05 | 0.05 | 0.05 | 0.05 | 0.05 | 0.05 | 0.05 |
| Nipagin M | 0.04 | 0.04 | 0.04 | 0.04 | 0.04 | 0.04 | 0.04 |
| Cobratec² | 0.88 | 0.88 | 0.88 | 0.88 | 0.88 | 0.88 | 0.88 |
| Glycerol | 17.81 | 17.81 | 17.81 | 17.81 | 17.81 | 17.81 | 17.81 |
| Propylene | 2.97 | 2.97 | 2.97 | 2.97 | 2.97 | 2.97 | 2.97 |
| Glycol | | | | | | | |
| Urea | 9.90 | 9.90 | 9.90 | 9.90 | 9.90 | 9.90 | 9.90 |

The above components are dissolved and the following are added under mild agitation:

| | | | | | | | |
|---|---|---|---|---|---|---|---|
| SF-5014 Orange | 44.52 | | | | | | |
| SF-5012 Green | | 44.53 | | | | | |
| SF-5013 Red | | | 44.53 | | | | |
| SF-5015 Lemon | | | | 44.53 | | | |
| Yellow | | | | | | | |
| SF-5017 Pink | | | | | 44.53 | | |
| SF-5037 Violet | | | | | | 44.53 | |
| SF-5018 Blue | | | | | | | 44.53 |
| Foammaster S³ | 0.04 | 0.03 | 0.03 | 0.03 | 0.03 | 0.03 | 0.03 |

The above are mixed and filtered and the following is added:

| | | | | | | | |
|---|---|---|---|---|---|---|---|
| Foammaster S | 0.04 | 0.03 | 0.03 | 0.03 | 0.03 | 0.03 | 0.03 |

The above is mixed.

1. Nipagin is an anti-microbial agent made by Nipa Lab, Ltd. in Wilmington, Del.

2. Cobratec is an anti-corrosive additive made by PMC Specialty Group in Cincinnati, Ohio.

3. Foammaster S is a defoaming agent made by Cognis in Kankakee, Ill.

All SF designated components are water-based fluorescent pigment dispersions made by Sinolihi, Ltd. located in Tokyo, Japan.

### Example 2

All inks listed in Example 1 exhibit excellent permanence as tested by the method described below.

This test evaluates the permanence of a written line of the ink composition of the present invention when exposed to water.

Equipment and Materials:

Deionized water

Eppendorf pipet with a range of 100-1000 uL, with tips

For free ink pens: Writing machine trace used for Line Intensity

Substrates for free ink pens:

4G cardboard

Glass (Pyrex)

LDPE 1/16 inch thickness part #8657K111 McMaster-Carr

Polypropylene 1/16 inch thickness part #8742K111 McMaster-Carr

Metal (aluminum foil)

Plywood (Birch cabinet grade)

Minitek paper

Sample Preparation:

Five samples.

Procedural Steps:

1. For permanent markers, one line of “Now is the time for all good men to come to the aid of their country,” is handwritten on each of the substrates. For free ink pens, the writing machine trace generated for the line intensity test is used.

2. After one minute, a 50 μL drop of deionized water is applied directly onto each writing sample.

3. The water drop is allowed to dry naturally overnight.

4. The water resistance is evaluated by the guidelines below.

Permanent—no color bleeding

Semi-pernanent—some color bleeding but the line is visible

Illegible—severe color bleeding and the line is not visible

### Example 3

All inks described in this Example exhibit a clean sharp line when applied to paper for greater than 90% of the total ink within the pen.

Example 3 provides shows a test to determine recovery and mileage.

The purpose of this test is to determine the percentage of total ink dispensed before a free ink pen does not give an acceptable handwrite (Recovery), and the total number of meters a free ink pen will give an acceptable handwrite (Mileage).

Equipment and Materials:

The writing machine is operated by the following guidelines:

6.6 m/min. speed

0.80 mm spacing between circles (paper feed+6)

70 degrees writing angle

Urethane rubber pad durometer: 85 Shore A

Standardized paper

Weights

Pen holders

Analytical balance accurate to 0.0001 g

Data form

Ampad legal pad (or equivalent)

Sample Preparation:

Minimum of five writing instruments.

Procedural Steps:

1. Handwriting is performed with each pen. The pens are weighed in their respective holders to establish their initial weights. The weights are recorded on a data form.

2. The pens are placed in their holders into the writing machine. The weights are added to total 45-47 grams on the point of the pen, including the pen and holder.

3. The pens are machine written for 200 meter laydown. The pens are weighed to obtain 200 meter laydown.

4. The pens are placed on the writing machine for an additional 800 meters.

5. After 800 meters, a one-line handwrite is made of each free ink pen. The free ink pen are machine written in 200 meter intervals, handwriting with each pen after each 200 meter machine write. When an unacceptable handwrite is obtained, the free ink pen's final weight is recorded. The procedure is continued until all five free ink pens have unacceptable handwrites.

6. The mileage is the total distance in meters at which the last acceptable handwrite was recorded. The mileage is reported as the average of all five pens.

7. The recovery is calculated as follows:

$$\% Recovery = \frac{Initial weight ( g ) - Final weight ( g )}{Ink Fill ( g )} \times 100$$

All patents cited in the foregoing text are expressly incorporated herein by reference in their entirety.

It will be understood that the claims are intended to cover all changes and modifications of the preferred embodiments of the invention, herein chosen for the purpose of illustration, which do not constitute a departure from the spirit and scope of the invention.

We claim:

1. A fluorescent ink composition for a free ink writing instrument comprising a fluorescent pigment dispersion, a water miscible organic solvent, a defoaming agent, and water, wherein the fluorescent pigment dispersion is a fluorescent colorant dispersed in a non-sulfonic acid-group containing resin.

2. The ink composition of claim 1, wherein the defoaming agent reduces foam and provides wetting properties in an interior delivery system of the free ink writing instrument to provide continuous writing.

3. The ink composition of claim 1, wherein the defoaming agent is a non-ionic, non-silicone defoaming agent.

4. The ink composition of claim 3, wherein the defoaming agent is a hydrocarbon based defoaming agent.

5. The ink composition of claim 4, wherein the hydrocarbon is a mineral oil.

6. The ink composition of claim 1, wherein the defoaming agent is present in the ink composition in an amount of about 1.0 weight percent or less of the ink composition.

7. The ink composition of claim 6, wherein the defoaming agent is present in the ink composition in an amount of about 0.01 weight percent to about 0.04 weight percent of the ink composition.

8. The ink composition of claim 1, wherein the ink composition has a viscosity of about 100 cPs or less at 20° C.

9. The ink composition of claim 1, wherein the ink composition has a surface tension of about 37 dyne-cm or less.

10. The ink composition of claim 1, wherein the fluorescent pigment dispersion is present in the ink composition in an amount from about 0.1 to about 60 weight percent of the ink composition.

11. The ink composition of claim 10 wherein the fluorescent pigment dispersion comprises an organic fluorescent pigment.

12. The ink composition of claim 11, wherein the pigment has a particle diameter of about 1.0 micron or less.

13. The ink composition of claim 12, wherein the pigment has a particle diameter of about 0.5 micron or less.

14. The ink composition of claim 1, wherein the organic solvent is from about 5 to about 90 weight percent of the ink composition.

15. The ink composition of claim 14, wherein the organic solvent is from about 20 to about 65 weight percent of the ink composition.

16. The ink composition of claim 1, wherein the organic solvent is selected from the group consisting of hydrocarbons, esters, alcohols, polyols, polyol ethers, ketones, pyrrolidones, lactones and mixtures thereof.

17. The ink composition of claim 16, wherein the polyol solvent is selected from the group consisting of ethylene glycol, diethylene glycol, triethylene glycol, polyethlene glycol, propylene glycol, 1,3-propane diol, 1,5-pentane diol, 1,2,6-hexane triol, glycerol and mixtures thereof.

18. The ink composition of claim 1, further comprising an additive to increase cap-off stability of the ink composition.

19. The ink composition of claim 18, wherein the additive is urea.

20. The ink composition of claim 1, wherein the ink composition exhibits a bright appearance on paper and within an ink storage member of the writing instrument.

21. A writing instrument comprising an ink storage member containing a fluorescent ink composition for a free ink writing instrument comprising a fluorescent pigment dispersion, a water miscible organic solvent, a defoaming agent, and water, wherein the fluorescent pigment dispersion is a fluorescent colorant dispersed in non-sulfonic acid-group containing resin.

22. The writing instrument of claim 21, wherein the ink storage member is made from a polymer material selected from the group consisting polyesters, polystyrene, high impact polystyrene, styrene-butadiene copolymers, impact modified styrene-butadiene copolymer, styrene acrylonitrile copolymers, acrylonitrile butadiene copolymers, polyisobutylene, vinyl, polyvinyl chloride, polyvinylidene chloride, polyvinyl acetals, polyacrylonitrile, polyacrylates, polymethacrylates, polymethylmethacrylates, polybutadiene, ethylene vinyl acetate, polyamides, polyimides, polyoxymethylene, polysulfones, polyphenylene sulfide, polyvinyl esters, melamines, vinyl esters, epoxies, polycarbonates, polyurethanes, polyether sulfones, polyacetals, phenolics, polyester carbonate, polyethers, polyethylene terephthalate, polytrimethylene terephthalate, polybutylene terephthalate, polyarylates, polyarylene sulfides, polyketones, polyethylene, high density polyethylene, polypropylene, fluoropolymer and copolymers, grafts, blends, and mixtures thereof.

23. The writing instrument of claim 21, wherein the writing instrument is usable on ink-absorbing surfaces.
